(19) United States
(12) Patent Application Publication
(10) Pub. No.: US 2001/0025731 A1
(43) Pub. Date: Oct. 4, 2001

(54) Load measurement

(76) Inventors: Paul John Corder, Auckland (NZ); Douglas John Rankin, Auckland (NZ); Frank James Perry, Auckland (NZ)

Correspondence Address: GREER, BURNS & CRAIN, 300 S WACKER DR, 25TH FLOOR, CHICAGO, IL, 60606, US

(21) Appl. No.: 09/808,252

(22) Filed: Mar. 14, 2001

(30) Foreign Application Priority Data
Mar. 15, 2000 (NZ) 503422

(51) Int. Cl. G01G 3/14; G01G 19/56; G01G 23/01

(52) U.S. Cl. 177/211; 73/1.13

(57) ABSTRACT

The present invention relates to a load measurement device for measuring the load on a load member, the device including,

a strain sensor attached to the load member by a locating means, and

a calibration arrangement located between one or both ends of the strain sensor and the location means, and

the calibration arrangement including a first thread on a first thread member and a second thread on a second thread member wherein the first and second threads are orientated in the same direction and the first and second threads have different pitches to one another, and a connecting member with threads at either end of said connecting member commensurate with the first and second threads formed within the first and second thread members.

### TECHNICAL FIELD

This invention relates to improvements in load measurement.

### BACKGROUND ART

There are many instances where the measurement of load on a load bearing member is important.

Of particular importance is the measurement of load in relation to heavy lifting equipment. Heavy lifting equipment includes hydraulically or mechanically operated diggers, hoists, front end loaders, cranes, refuse collection vehicles and the like.

Most heavy lifting machinery used powered hydraulics to power the rams used in the lifting process.

A common method for measuring the load on the members forming the lifting mechanism is to use pressure transducers within the hydraulic system to measure the pressure of the hydraulic fluid. This can then be converted into a measurement of the load on the lifting mechanism or the particular member involved

It is also known to use strain sensors on the members to measure the change in length of a member under load, and taking a load measurement from that.

However, current methods have a number of disadvantages. It is normally only commercially cost effective to use pressure transducers in hydraulic hoses where the hydraulic hoses are of a large diameter or relatively short. The transducers do not work as well or are uneconomical with hoses of smaller diameter because of the pressure drops present in the system. Thus the present systems lack versatility in terms of being applied to a variety of lifting equipment with varying diameter hoses.

Where strain sensors have been used to measure the load on a member, problems arise in the installation and calibration of the gauges.

The changes in length that are used to measure the strain are in the order of thousandths of an inch.

It is also extremely important that the brackets fixing the strain sensor to the member are as precisely aligned as possible to prevent distortion of the strain sensor would otherwise give an erroneous load reading.

The very act of welding or attaching the brackets to the member has the effect of putting the strain sensor under tension sufficiently to be read by the electronics that detects the change in strain.

Therefore very precise welding is required.

Further, present strain sensor load measurement systems are difficult to calibrate.

Environmental effects such as temperature and sunlight will all affect the amount of strain put on the strain sensor and the amount of inherent distortion due to he change in state of the materials within the strain sensor.

What is needed then is a measurement device and system that can cope with a number of different of strain measurement applications, and can be more easily installed.

It is an object of the present invention to a the foregoing problems or at least to provide the public with a useful choice.

Further aspects and advantages of the present invention will become apparent from the ensuing description that is given by way of example only.

### DISCLOSURE OF INVENTION

According to one aspect of the present invention there is provided a load measurement device for measuring the load on a member, the device including,

a strain sensor,

at least two universal joints configured to attach the strain sensor to a member, wherein the universal joints are located distal from one another when used to attach the strain sensor to the member.

According to a further aspect of the present invention there is provided a load measurement device for measuring the load on a load member, the device including,

a strain sensor, attachable to a load member via a location means, and

a calibration arrangement located between one or both ends of the strain sensor and the location means, and

the calibration arrangement including a first thread on a first thread member and a second thread on a second thread member wherein the first and second threads are orientated in the same direction and the first and second threads have different pitches to one another, and a connecting member with threads at either end of said connecting member commensurate with the first and second threads formed within the first and second thread members.

According to a further aspect of the present invention there is provided a load measurement device for measuring the lead on a load member, which includes

a strain sensor,

at least two universal joints to attach the strain sensor to the load member,

a calibration arrangement which includes a first thread on a first thread member and a second thread on a second thread member, the first and second threads being orientated in the same direction and the first and second threads having different pitches from one another, and a connecting member with threads at each end of said connecting member commensurate with the first and second threads,

wherein the calibration arrangement is located between the strain sensor and a universal joint.

According to a further aspect of the present invention there is provided a load bearing member having a strain measurement arrangement as described above attached thereto.

A further embodiment of the present invention may incorporate measurement electronics to convert the strain sensor readings into a meaningful form.

The electronic monitoring circuitry used to decipher the measurements taken from the strain sensor may include any suitable electronic monitoring equipment which can receive electronic signals from the strain sensor.

For example this may include microcontrollers, the use of programmable logic, weight indicators, computers, analog circuitry and remote V/F, V/PWM, and V/Serial Code inverters coupled back to a cab mounted indicator and so forth.

Preferably the load measurement device may include signal conditioning circuitry which is adapted to condition a signal received from the strain sensor. Preferably such signal conditioning circuitry may be used to reduce unwanted signal noise or interference.

A signal conditioning circuit or device may be located near the strain sensor to condition the signal received from the strain measurement transducer. The conditioning device may condition the signal so that it is at an appropriate level or in an appropriate form so as to be easily processed by the appropriate electronic measuring equipment.

Failure to appropriately condition the signal may result in noise interference.

The strain sensor may take various forms.

For example, it may be an active transducer or a passive transducer.

The strain sensor may be a load cell, but may be any device whereby the movement forming the strain on the member as a result of load or stress on the member.

Reference to a universal joint refers to a joint that can move in all planes.

This may include a ball joint, a double clevis joint and so forth.

The essential requirement is that the universal joints work together to maintain the strain sensor within the plane of interest.

Reference to a member may include any load bearing or potentially load bearing member in a structure. For example, this may include beam members in a building structure, parts of a lifting mechanism, structural members of a vehicle and so forth.

Preferably the member may be a load bearing member in hydraulic lifting equipment. However those skilled in the art should appreciate that the present invention may be used in conjunction with any form of lifting member or lifting arm which is placed under load in use. Reference to excavator arms or particularly hydraulic lifting equipment throughout this specification should in no way be seen as limiting.

A further aspect of the present invention may provide for the provision of an attachment means to fit a cover over the device once attached to the member.

Preferably the load measurement device may include an attachment means adapted to fit a cover over the strain sensor, where the cover is used to block sunlight from shining on the strain sensor and will also allow air to circulate past the strain sensor.

The attachment means may include holes, clips, magnetic attachments, bayonet clips and so forth.

Preferably however the attachment means for the cover may include holes formed in the universal joint lugs which can be used to weld the strain sensor to the member.

There may also be provided a cover designed to block out the sunlight and to allow a circulation of air past the area of the member to which the present invention is attached.

This is important as warping from heat or the sun of the member will affect the strain sensor readings.

The cover will prevent sunlight from heating one section of the member more than the other.

It may be configured so as to include a mating attachment to attach to the cover attachment means, and be manufactured of some suitable materials to form a shell surrounding the member, or partially surrounding the member.

There may also be provided an air gap between the member and the cover.

The present invention may also include a locking means that locks the connecting member in place once the device is calibrated.

The applicant envisages the use of a grub screw, an adhesive compound, a self locking nut or some other functionally equivalent device. Further embodiments may make use of a thread locking compound such as “LOCTITE™”.

It is envisaged that the connecting member may comprise a substantially tubular element with threads born in either end that are commensurate with the first and second threads formed in the first and second thread members.

In a preferred configuration the first and second threads will be located on two thread members, the first connected to the strain sensor, and the second to the location means distil from the strain sensor with the connecting means disposed therebetween.

The present invention has a number of potential advantages.

The applicant has found that the provision of universal joints eliminates or greatly minimizes any anomalies that may occur to the readings taken from the strain sensor that occur as a result of misalignment in the mounting process or from welding.

This is because the ball joints tend to keep the strain sensor in the plane of interest, which is the plane in which the most strain will occur.

Preferably the present invention may be mounted length ways with the member.

In some configurations, there may be provided plurality of strain sensors according to the present invention on different faces of a load bearing member.

In some embodiments the strain sensors may be located on opposite faces.

The applicant has found that the present invention allows previously determined mathematical formulas to be used in the correction of moment arm error.

Moment arm error occurs when the load on the beam is increased, not so much as because of the materials being lifted by the beam (for example in the case of a skip bin truck), but that the heavier contents of the skip bin are at the far edge of the bin and therefore exert a greater turning moment on the beam.

Previously all calculations had to assume that the centre of gravity on the load being lifted by the beam were at the centre of the item.

However with the present invention it is possible to account for any increased load measurements as a result of items of various weights being distributed throughout the skip bin or other load by including a second strain sensor on the member. This has been found to be of great advantage.

The applicant has found that the use of the calibration adjustment is a very cost efficient way of achieving of minute increments of strain sensor.

The use of two same orientation, but different pitch screw threads is advantageous over using a turn buckle arrangement (where the threads would have opposite orientations), because with turn buckle arrangements, one tun will give movement two times the pitch of the thread.

Although this is conceivably within the scope of the present invention, the applicant has found that the movement achieved by the turn buckle arrangement is sometimes higher than required, given that the measurement is within he order of a thousandths of an inch.

With the preferred configuration of either two right handed or two left handed screw thread of different pitch, one turn gives movement of the difference between the two pitches.

Thus very small increments of movement are achievable.

The provision of a cover is also important as it potentially prevents or alleviates any warping that may occur to the member through contact with sunlight.

The cumulative affect of the present invention is that it provides very accurate and reliable load measurement via the use of the strain sensor, while doing so in a convenient and economical way.

The advantages of the preset invention alluded to above mean that although the attachment to the member should be as precise as possible, ordinary welding can be used instead of precision welding which makes the process more economical as specialist equipment and expertise is not required.

The present invention may therefore be used to measure load on hydraulic lifting equipment having small diameter hoses and/or where there are significant pressure drops in the system.

However, the present invention may also have applications in structural beam load measurement, or measurement on heavier lifting equipment.

### BRIEF DESCRIPTION OF DRAWINGS

Further aspects of the present invention will become apparent from the following description which is given by way of example only and with reference to the accompanying drawings in which:

FIG. 1 shows a side on view of a preferred embodiment of the present invention;

FIG. 2 shows a plan view of the embodiment of FIG. 1, and

FIG. 3 shows mounting holes in accordance with an aspect of the present invention.

### BEST MODES FOR CARRYING OUT THE INVENTION

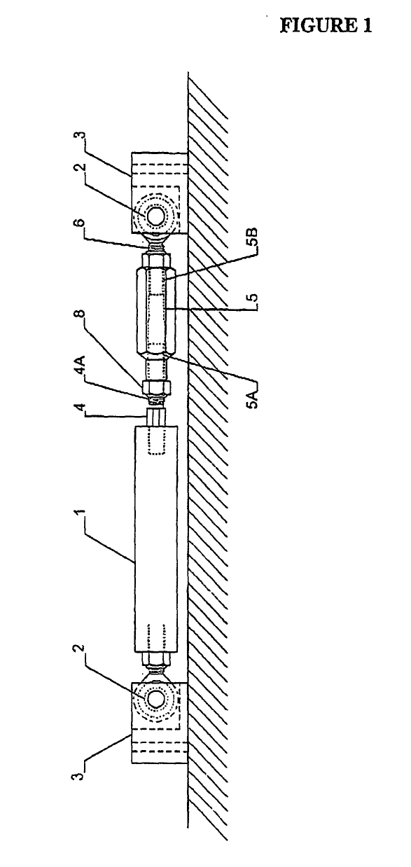

With reference to FIG. 1 there is shown an embodiment of the present invention which includes a strain sensor 1. The strain sensor 1 is mounted via a ball and socket joint 2 to an attachment lug 3. At the other end of the strain sensor, a first threaded member 4 is attached. These elements, used to attach the stain sensor to a member, may be described as a locating means. At the threaded end 4A of the first threaded member 4, a like thread is formed in an adjustment rod 5. At the other end of the adjustment rod 5 is a further thread 5B. At the end adjacent the first threaded member 4 is a like thread 5A.

A second thread member 6 having a thread commensurate with thread 5B is inserted into the rod 5. The second threaded member 6 is connected via a ball and socket joint 2, and attachment lug 3.

There may also be provided a locking mechanism 8.

The pitches of threads 5A and 5B are to be both left handed or right handed threads, but have a different pitch. For example thread 5A may have a pitch of 1.1 mm, whereas the pitch of 5B may have a pitch of 1 mm.

The strain sensor 1 may be monitored by the appropriate electronics to convert the strain measurement from the strain sensor into an acceptable and useful electronic signal to measure load.

For example this may include micro-controllers, programmable logic, weight indicators, computers, and analog, remote V/F, V/PWM, and V/Serial Code inverters coupled back to a cab mounted indicator, and so forth.

A signal conditioning circuit or device (not shown) may be located near the strain sensor to condition the signal received from the strain measurement transducer. The conditioning device may condition the signal so that it is at an appropriate level or in an appropriate form so as to be easily processed by the appropriate electronic measuring equipment.

Failure to condition the signal may result in unwanted noise interference affecting the signal.

The applicant is presently using a strain sensor bridge measurement circuit which measures voltage off the bridge then converts to a 0-20 mA current loop. The configuration has advantages because of low noise susceptibility.

The applicant has found that the appropriate signal conditioning can be used in combination with certain arrangements to provide a correction for moment arm error using appropriate mathematics.

A preferred configuration (not shown in the figures) is to have a strain sensor as shown in FIG. 1 on either side of a load bearing member and conditioning signals accordingly. The applicant has found that by the suitable mathematical processes, the signals can make the correction for moment arm error. Thus it need not be assumed that the centre of gravity of the skip being lifted by lifting machinery is in the centre of the skip.

A more accurate load measurement is the result.

The applicant had found that previously the mathematical models while working in theory had not been able to be applied in practice. However the provision of the present invention and the fine adjustment achievable has allowed this to be worked in practice.

The attachment lugs are fixed to a load bearing member 10.

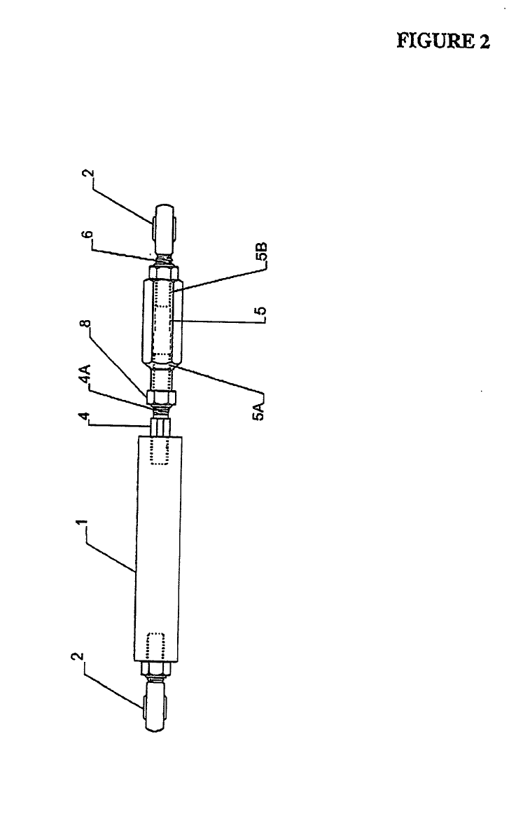

A plan view of the arrangement in FIG. 1 is shown in FIG. 2.

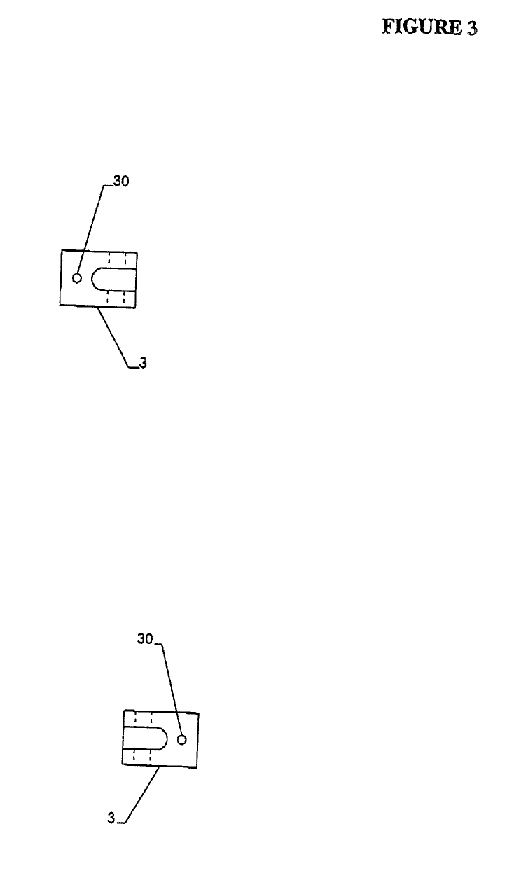

FIG. 3 shows the end lugs. The end lugs 3 include mounting holes 30. The mounting holes are intended to mount a sunshade or cover (not shown) to prevent heat from sunlight from unevenly heating part of the load bearing member to which the device of the present invention is attached.

The cover may take the form of a shell or umbrella type arrangement, having projections that fit into the mounting holes to maintain the cover in position.

It is envisaged that the present invention will have use in load measurement in hydraulic lifting equipment having narrow hoses, or where there is significant pressure drops in the system, making pressure transducers ineffective or uneconomical. In particular, this may be applications such as skip-bin lifters.

Aspects of the present invention have been described by way of example only and it should be appreciated that modifications and additions may be made thereto without departing from the scope thereof as defined in the appended claims.

The claims defining the invention are:

1. A load measurement device for measuring the load on a load member, the device including,
a strain sensor attached to the load member by a locating means, and
a calibration arrangement located between one or both ends of the strain sensor and the location means, and
the calibration arrangement including a first thread on a first thread member and a second thread on a second thread member wherein the first and second threads are orientated in the same direction and the first and second threads have different pitches to one another, and a connecting member with threads at either end of said connecting member commensurate with the first and second threads formed within the fist and second thread members.

2. A load measurement device as claimed in claim 1 wherein the member is incorporated within a load bearing structure.

3. A load measuring device as claimed in claim 1 wherein the member is incorporated into hydraulic lifting equipment.

4. A load measurement device as claimed in claim 1 wherein the strain sensor is adapted to sense a movement forming a strain on the member as a result of a load or stress placed on the member.

5. A load measurement device as claimed in claim 1 wherein the strain sensor is formed from an active or passive transducer.

6. A load measurement device as claimed in claim 1 wherein the strain sensor is formed from a load cell.

7. A load measurement device as claimed in claim 1 which includes an attachment means adapted to fit a cover over the strain sensor, said cover blocking sunlight from shining on the strain sensor and allowing air to circulate past the strain sensor.

8. A load measurement device as claimed in claim 1 which includes signal conditioning circuitry adapted to condition a signal received from the strain sensor.

9. A load measurement device as claimed in claim 8 wherein the signal conditioning circuitry reduces unwanted signal noise or interference.

10. A load measurement device as claimed in claim 1 which includes electronic monitoring circuitry used to receive electrical signals from the strain sensor.

11. A load measurement device as claimed in any previous claim wherein the connecting member is formed from a substantially tubular element with threads bored at either end which are commensurate with the first and second threads formed in the first and second thread members.

12. A load measurement device as claimed in claim I wherein the first and second threads are formed within a first and a second thread member, wherein the first thread member is connected to the strain sensor, and the second tread member is attached to the portion of the location means distal from the strain sensor, with the connecting member is disposed between said first and second thread members.

13. A load measurement device for measuring the load on a load member which includes,
a strain sensor, and
at least two universal joints used to attach the strain sensor to the load member, and
a calibration arrangement which includes a first head on a first thread member and a second thread on a second thread member, the first and second threads being orientated in the same direction and the first and second threads having different pitches from one another, and a connecting member with threads at each end of said connecting member commensurate with the first and second threads,
wherein the calibration arrangement is located between the strain sensor and a universal joint.

14. A load measurement device as claimed in claim 13 wherein a universal joint is formed from a joint which can move in all planes.

15. A load measurement device as claimed in claim 13 wherein the said at least two universal joints are farmed from ball joints or double clevis joints.

16. A load measurement device as claimed in claim 1 which includes a locking means to lock the connecting member of the calibration arrangement in place once the load measurement device is calibrated.

17. A load measurement device as claimed in claim 16 wherein the locking means is formed from a grub screw, self locking nut and/or an adhesive compound.

18. A load measuring device for measuring the load on a member, the device including:
a strain sensor, and
at least two universal joints configured to attach the strain sensor to the member,
wherein the universal joints are located distal from one another when used to attach the strain sensor to the member.

19. A load bearing member which includes a load measurment device as claimed in claim 1.
